(19) United States
(12) Patent Application Publication
(10) Pub. No.: US 2021/0408851 A1
(43) Pub. Date: Dec. 30, 2021

(54) ROTOR, MOTOR, FAN, AIR CONDITIONER, AND MANUFACTURING METHOD OF ROTOR

(71) Applicant: Mitsubishi Electric Corporation, Tokyo (JP)

(72) Inventors: Ryogo TAKAHASHI, Tokyo (JP); Hiroki ASO, Tokyo (JP); Takaya SHIMOKAWA, Tokyo (JP); Kazuma NOMOTO, Tokyo (JP)

(21) Appl. No.: 17/289,884

(22) PCT Filed: Dec. 20, 2018
(86) PCT No.: PCT/JP2018/046928

§ 371 Date: Apr. 29, 2021

(51) Int. Cl. H02K 1/27; H02K 15/03; H02K 7/14

(52) U.S. Cl. CPC H02K 1/276; H02K 2213/03; H02K 7/14; H02K 15/03

(57) ABSTRACT

A rotor includes a shaft, an annular rotor core surrounding the shaft from an outer side in a radial direction about a center axis of the shaft, a magnet attached to the rotor core, and a separating portion provided between the shaft and the rotor core and formed of a nonmagnetic body. The magnet constitutes a first magnetic pole, and a part of the rotor core constitutes a second magnetic pole. The rotor core has an inner circumference facing the shaft and an outer circumference opposite to the inner circumference. The separating portion has an outer circumference in contact with the inner circumference of the rotor core. A radius R1 of the shaft, a minimum distance R2 from the center axis to the outer circumference of the separating portion, and a maximum distance R3 from the center axis to the outer circumference of the rotor core satisfy (R2−R1)/(R3−R2)≥0.41.

### CROSS REFERENCE TO RELATED APPLICATION

This application is a U.S. national stage application of International Patent Application No. PCT/JP2018/046928 filed on Dec. 20, 2018, the disclosure of which is incorporated herein by reference.

### TECHNICAL FIELD

The present invention relates to a rotor, a motor, a fan, an air conditioner, and a manufacturing method of a rotor.

### BACKGROUND ART

Recently, there has been developed a consequent pole rotor which includes a first magnetic pole constituted by a magnet embedded in a rotor core and a second magnetic pole constituted by a portion of the rotor core adjacent to the magnet (see Patent Reference 1).

### PATENT REFERENCE

### Patent Reference 1

Japanese Patent Application Publication No. 2015-92828 (see FIG. 2)

In the consequent pole rotor, a magnetic flux of the rotor core tends to flow to a shaft because no magnet is provided in the second magnetic pole. When such magnetic flux leakage occurs, motor efficiency decreases.

### SUMMARY

The present invention is made to solve the above-described problem, and an object of the present invention is to reduce magnetic flux leakage to a shaft in a consequent pole rotor.

A rotor of the present invention includes a shaft, an annular rotor core surrounding the shaft from an outer side in a radial direction about a center axis of the shaft, a magnet attached to the rotor core, and a separating portion provided between the shaft and the rotor core and formed of a nonmagnetic body. The magnet constitutes a first magnetic pole, and a part of the rotor core constitutes a second magnetic pole. The rotor core has an inner circumference facing the shaft and an outer circumference opposite to the inner circumference. The separating portion has an outer circumference in contact with the inner circumference of the rotor core. A radius R1 of the shaft, a minimum distance R2 from the center axis to the outer circumference of the separating portion, and a maximum distance R3 from the center axis to the outer circumference of the rotor core satisfy (R2−R1)/(R3−R2)≥0.41.

According to the present invention, the separating portion formed of the nonmagnetic body is provided between the shaft and the rotor core, and (R2−R1)/(R3−R2)≥0.41 is satisfied. Thus, the magnetic flux is less likely to flow from the rotor core to the shaft. That is, the magnetic flux leakage to the shaft can be reduced.

### BRIEF DESCRIPTION OF THE DRAWINGS

FIG. 1 is a partial sectional view illustrating a motor in a first embodiment.

FIG. 2 is a plan view illustrating a stator core in the first embodiment.

FIG. 3 is a longitudinal sectional view illustrating a rotor in the first embodiment.

FIG. 4 is an enlarged longitudinal sectional view illustrating the rotor in the first embodiment.

FIG. 5 is a sectional view illustrating the rotor in the first embodiment.

FIG. 6 is a front view illustrating the rotor in the first embodiment.

FIG. 7 is a rear view illustrating the rotor in the first embodiment.

FIG. 8 is a schematic diagram illustrating dimensions of parts of the rotor in the first embodiment.

FIG. 9 is a graph showing a relation between (R2−R1)/(R3−R2) and an induced voltage in the first embodiment.

FIG. 10 is a longitudinal sectional view illustrating a molding mold in the first embodiment.

FIG. 11 is a flowchart illustrating a manufacturing process of the rotor in the first embodiment.

FIG. 12 is a sectional view illustrating a rotor in a first modification of the first embodiment.

FIG. 13 is a sectional view illustrating a rotor in a second modification of the first embodiment.

FIG. 14 is an enlarged sectional view illustrating the rotor in the second modification of the first embodiment.

FIG. 15(A) is a diagram illustrating a configuration example of an air conditioner to which the motors of the first embodiment and the modifications are applicable, and FIG. 15(B) is a sectional view illustrating an outdoor unit of the air conditioner.

### DETAILED DESCRIPTION

Hereinafter, an embodiment of the present invention will be described in detail with reference to the drawings. The present invention is not limited to the embodiment.

### First Embodiment

### (Configuration of Motor 1)

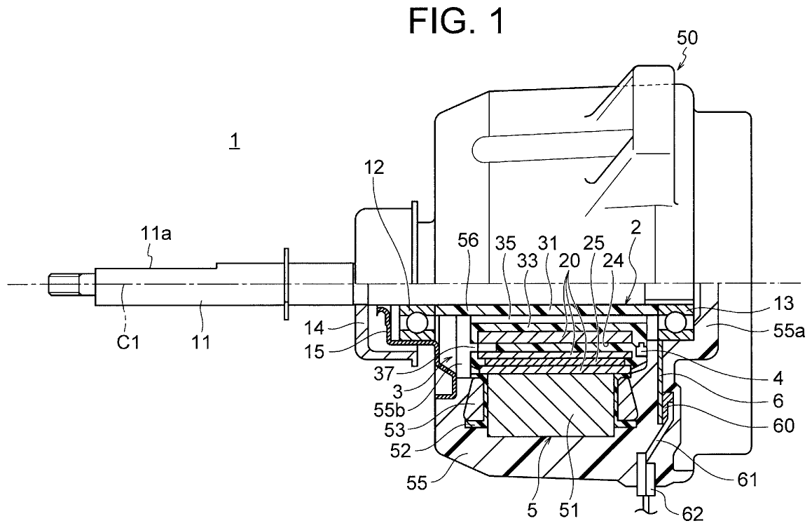

FIG. 1 is a longitudinal sectional view illustrating a motor 1 according to a first embodiment of the present invention. The motor 1 is, for example, a brushless DC motor that is used in a fan of an air conditioner and is driven by an inverter. The motor 1 is an interior permanent magnet (IPM) motor with magnets 25 embedded in a rotor 2.

The motor 1 includes the rotor 2 having a shaft 11 and a mold stator 50 surrounding the rotor 2. The mold stator 50 includes an annular stator 5 surrounding the rotor 2 and a mold resin portion 55 covering the stator 5. The shaft 11 is a rotation shaft of the rotor 2.

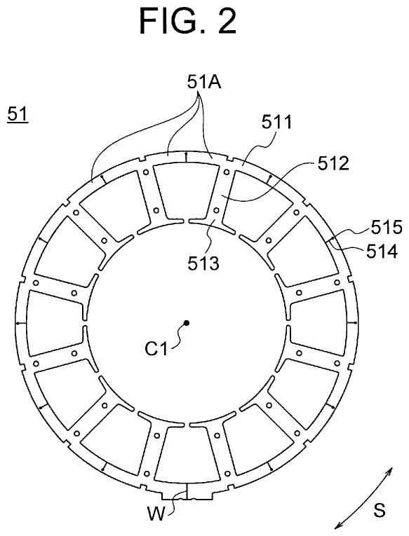

Hereinafter, a direction of a center axis C1 of the shaft 11 is referred to as an “axial direction”. A circumferential direction (indicated by an arrow S in FIG. 2 and the like) about the center axis C1 of the shaft 11 is referred to as a “circumferential direction”. A radial direction about the center axis C1 of the shaft 11 is referred to as a “radial direction”. Further, a sectional view in a plane parallel to the axial direction is referred to as a “longitudinal-sectional view”.

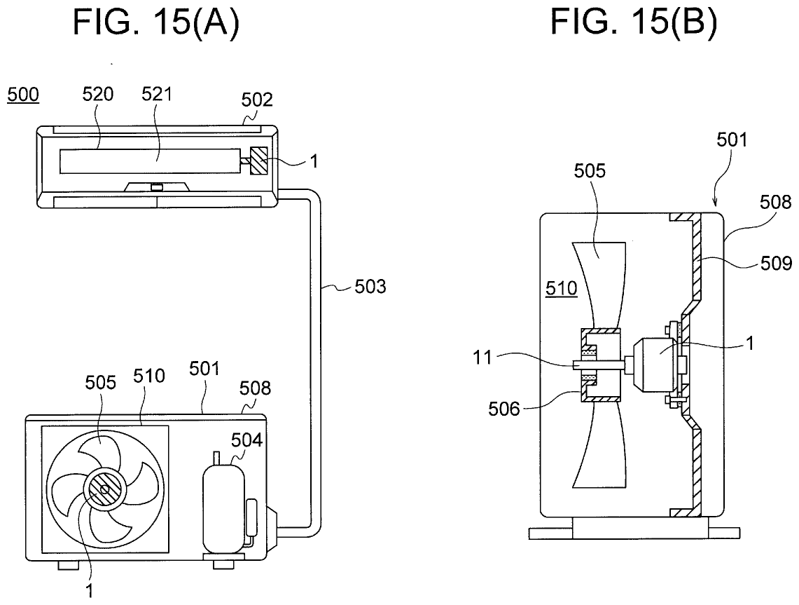

The shaft 11 protrudes from the mold stator 50 to the left in FIG. 1. A blade 505 (FIG. 15(A)) of a fan, for example, is attached to an attachment portion 11a formed on the protruding portion of the shaft 11. Therefore, the protruding side (the left side in FIG. 1) of the shaft 11 is referred to as a “load side”, and the opposite side (the right side in FIG. 1) is referred to as a “counter-load side”.

### (Configuration of Mold Stator 50)

The mold stator 50 includes the stator 5 and the mold resin portion 55 as described above. The stator 5 surrounds the rotor 2 from the outer side in the radial direction. The stator 5 includes a stator core 51, an insulating portion (an insulator) 52 provided on the stator core 51, and a coil (a winding) 53 wound on the stator core 51 via the insulating portion 52.

The mold resin portion 55 is formed of a thermosetting resin such as a bulk molding compound (BMC). The mold resin portion 55 includes a bearing support 55a on one side in the axial direction (in this example, the counter-load side) and an opening 55b on the other side (in this example, the load side). The rotor 2 is inserted into a hollow portion 56 inside the mold stator 50 through the opening 55b.

A bracket 15 made of a metal is attached to the opening 55b of the mold resin portion 55. One bearing 12 supporting the shaft 11 is held by the bracket 15. A cap 14 for preventing intrusion of water or the like is attached outside the bracket 15. The bearing support 55a of the mold resin portion 55 has an inner circumferential surface having a cylindrical shape. The other bearing 13 supporting the shaft 11 is held on the inner circumferential surface.

FIG. 2 is a plan view illustrating the stator core 51. The stator core 51 includes a plurality of stacking elements that are stacked in the axial direction and integrally fixed by crimping, welding, bonding, or the like. The stacking elements are, for example, electromagnetic steel sheets. The stator core 51 includes a yoke 511 that extends annularly in the circumferential direction about the center axis C1 and a plurality of teeth 512 extending inward in the radial direction (toward the center axis C1) from the yoke 511. A tooth tip end 513 on an inner side of each tooth 512 in the radial direction faces an outer circumferential surface of the rotor 2 (FIG. 1). The number of teeth 512 is 12 in this example, but is not limited to 12.

The stator core 51 is divided into a plurality of (in this example, 12) split cores 51A each including one tooth 512 in this example. The split cores 51A are divided by split surfaces 514 formed in the yoke 511. The split surfaces 514 extend from the inner circumferential surface of the yoke 511 to an outer side in the radial direction. A thin portion 515 that is plastically deformable is formed between a terminal end of the split surface 514 and the outer circumferential surface of the yoke 511. Because of plastic deformation of the thin portions 515, the stator core 51 can be extended in a band shape.

This configuration makes it possible to wind the coil 53 around the teeth 512 in a state where the stator core 51 is extended in a band shape. After the coil 53 is wound, the band-shaped stator core 51 is assembled into an annular shape, and both ends (indicated by reference character W in FIG. 2) of the stator core 51 are welded. The stator core 51 is not limited to a combination of the split cores and may have an integrated configuration.

In FIG. 1, the insulating portion 52 is formed of, for example, a thermoplastic resin such as PBT (polybutylene terephthalate). The insulating portion 52 is formed by integrally molding the thermoplastic resin with the stator core 51 or by assembling a molded body of the thermoplastic resin to the stator core 51.

The coil 53 is formed by winding a magnet wire around the teeth 512 (FIG. 2) via the insulating portion 52. The insulating portion 52 has walls on the inner side and the outer side of the coil 53 in the radial direction and guides the coil 53 from both sides in the radial direction.

A substrate 6 is disposed on one side in the axial direction (in this example, the counter-load side) with respect to the stator 5. The substrate 6 is a printed circuit board on which a driving circuit 60 such as a power transistor for driving the motor 1, a magnetic sensor, and the like are mounted and lead wires 61 are wired. The lead wires 61 on the substrate 6 are drawn out to the outside of the motor 1 through a lead wire outlet part 62 attached to an outer circumferential portion of the mold resin portion 55.

The bracket 15 is press-fitted into an annular portion provided on the outer circumferential edge of the opening 55b of the mold resin portion 55. The bracket 15 is formed of a metal having electric conductivity such as, for example, a galvanized steel sheet, but the bracket 15 is not limited thereto. The cap 14 is attached outside the bracket 15 and prevents intrusion of water or the like into the bearing 12.

### (Configuration of Rotor 2)

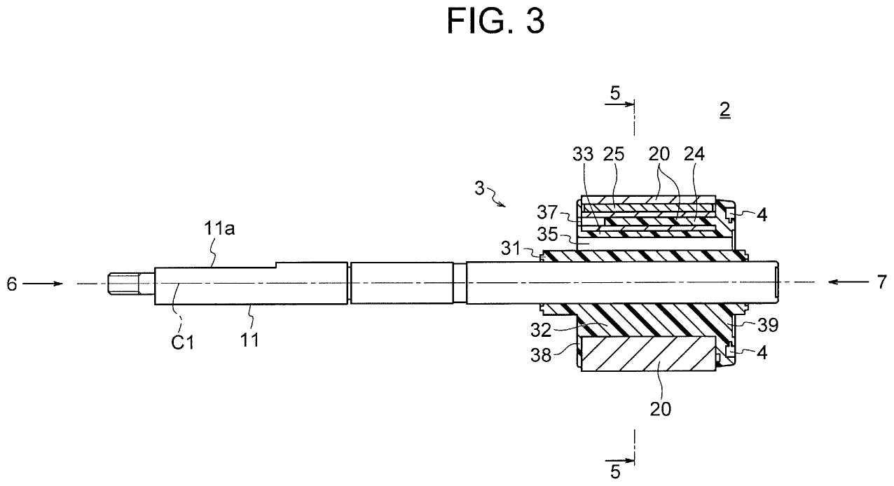

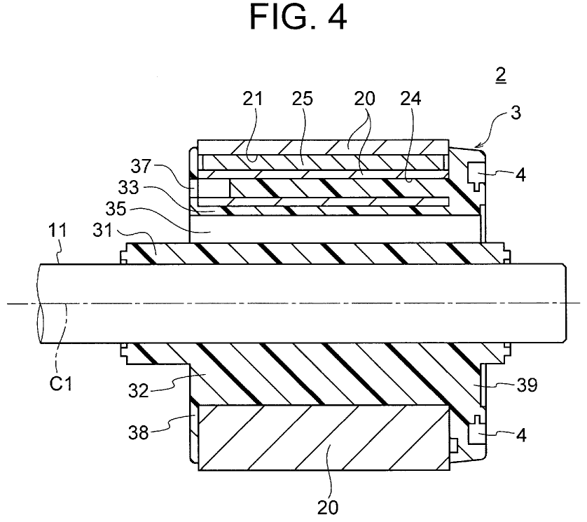

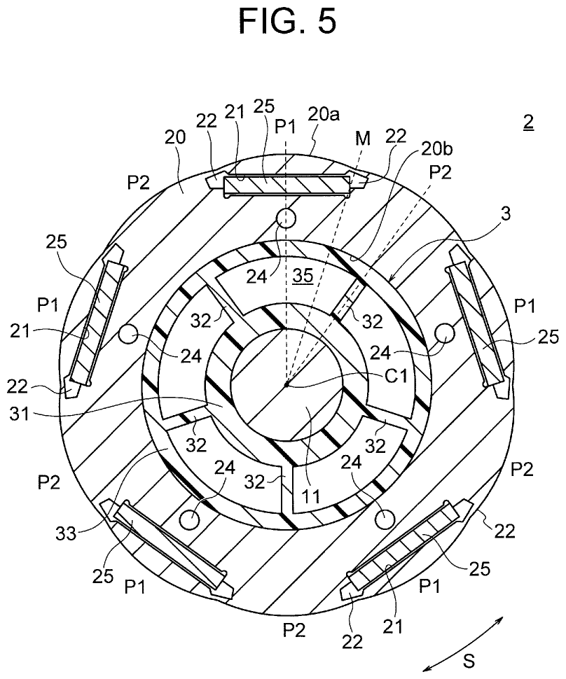

FIG. 3 is a longitudinal sectional view illustrating the rotor 2. FIG. 4 is an enlarged longitudinal cross-sectional view illustrating a part of the rotor 2. FIG. 5 is a sectional view taken along line 5-5 in FIG. 3 as seen in the direction indicated by arrows.

As illustrated in FIG. 5, the rotor 2 includes the shaft 11 that is a rotation shaft, a rotor core 20 provided on the outer side in the radial direction with respect to the shaft 11 to be spaced apart from the shaft 11, a plurality of magnets 25 embedded in the rotor core 20, and a separating portion 3 provided between the shaft 11 and the rotor core 20. The number of magnets 25 is five in this example. The magnets 25 are also referred to as main magnets or rotor magnets.

The shaft 11 is made of a magnetic material such as S45C (carbon steel). The shaft 11 has a cross section that is circular about the above-described center axis C1 and has a radius R1. S45C has the advantages of lower material cost and easier processability, as compared to SUS304 (stainless steel).

The rotor core 20 is a member that is annular about the center axis C1. The rotor core 20 has an outer circumference 20a and an inner circumference 20b. The inner circumference 20b faces the shaft 11 at a distance therefrom. The rotor core 20 includes a plurality of stacking elements of a soft magnetic material that are stacked in the axial direction and fixed by crimping, welding, bonding, or the like. The stacking elements are, for example, electromagnetic steel sheets each having a thickness of 0.1 mm to 0.7 mm.

The rotor core 20 has a plurality of magnet insertion holes 21 in the circumferential direction. The magnet insertion holes are arranged at equal intervals in the circumferential direction and are disposed at equal distances from the center axis C1. The number of magnet insertion holes 21 is five in this example. The magnet insertion holes 21 are formed along the outer circumference 20a of the rotor core 20, and pass through the rotor core 20 in the axial direction.

The magnet 25 is inserted in each magnet insertion hole 21. The magnet 25 is in the form of a flat plate and has a rectangular cross-sectional shape perpendicular to the axial direction. The magnet 25 is a rare earth magnet and is, more specifically, a neodymium sintered magnet containing Nd (neodymium)-Fe (iron)-B (boron) as main components. A flux barrier 22 which is an opening is formed at each end of the magnet insertion hole 21 in the circumferential direction. The flux barriers 22 suppress shortcircuit of magnetic flux between the adjacent magnets 25.

The magnets 25 are all arranged in such a manner that the same magnetic poles (for example, the N-poles) face the outer circumferential side of the rotor core 20. In the rotor core 20, magnetic poles (for example, the S-poles) opposite to those of the magnets 25 are formed in regions between the magnets 25 adjacent in the circumferential direction.

Thus, five first magnetic poles P1 (for example, the N-poles) and five second magnetic poles P2 (for example, the S-poles) are alternately arranged in the circumferential direction in the rotor 2. Therefore, the rotor 2 has 10 magnetic poles. The 10 magnetic poles P1 and P2 of the rotor 2 are arranged at equal intervals in the circumferential direction with a pole pitch of 36 degrees (360 degrees divided by 10).

That is, five magnetic poles (the first magnetic poles P1), which correspond to a half of the 10 magnetic poles P1 and P2 of the rotor 2, are formed by the magnets 25, while the remaining five magnetic poles (the second magnetic poles P2) are formed by the rotor core 20. This configuration is referred to as a consequent pole type. Hereinafter, when the term “magnetic poles” is simply used, this includes both the first magnetic poles P1 and the second magnetic poles P2.

The outer circumference 20a of the rotor core 20 has a so-called flower circle shape in a cross section perpendicular to the axial direction. In other words, the outer circumference 20a of the rotor core 20 has such a shape that the outer diameter of the rotor core 20 is maximum at the pole center (that is, the center in the circumferential direction) of each of the magnetic poles P1 and P2 and is minimum at an inter-pole portion M (a portion between adjacent magnetic poles). The outer circumference 20a has an arc shape from the pole center to the inter-pole portion M. The outer circumference 20a of the rotor core 20 is not limited to the flower circle shape and may be a circular shape. Meanwhile, the inner circumference 20b of the rotor core 20 has a circular shape in a cross section perpendicular to the axial direction.

In the consequent pole rotor 2, the number of magnets 25 can be halved as compared to a non-consequent pole rotor having the same number of poles. Since the number of expensive magnets 25 is small, the manufacturing cost of the rotor 2 is reduced.

Although the number of poles of the rotor 2 is 10 in this example, it is sufficient that the number of poles of the rotor 2 is an even number of four or more. Moreover, although one magnet 25 is disposed in each magnet insertion hole 21 in this example, two or more magnets 25 may be disposed in each magnet insertion hole 21. The first magnetic pole P1 may be the S-pole and the second magnetic pole P2 may be the N-pole.

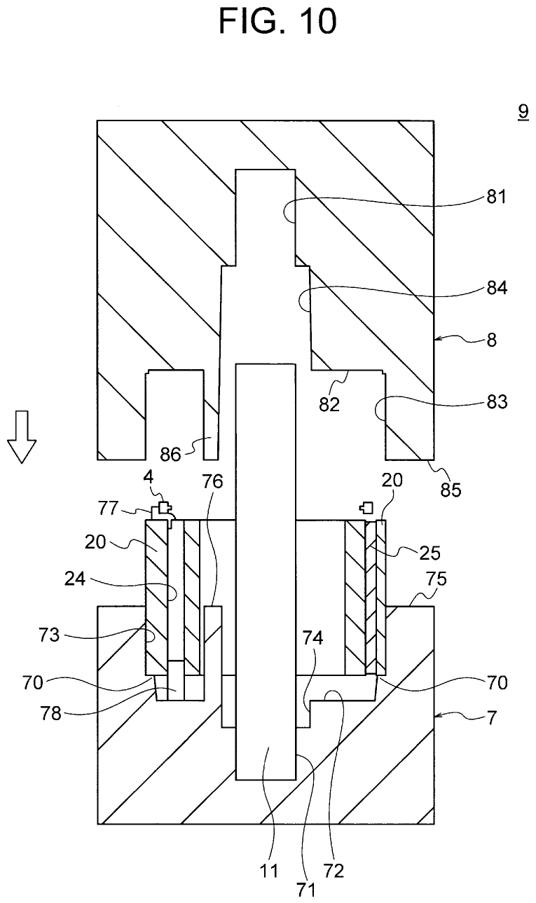

In the rotor core 20, a plurality of core holes 24 are formed on the inner side of the magnet insertion holes 21 in the radial direction. The number of core holes 24 is, for example, half the number of poles, and is five in this example. The core holes 24 are provided to engage with positioning pins 78 of a molding mold 9 (FIG. 10) described later to thereby position the rotor core 20 in the molding mold 9.

The core holes 24 are disposed at equal distances from the center axis C1, and are disposed at the same relative positions with respect to the closest magnetic poles. In this example, each core hole 24 is formed on the inner side of the pole center of the first magnetic pole P1 in the radial direction. With this arrangement, the pins 78 of the molding mold 9 can be engaged with any core holes 24 of the rotor core 20.

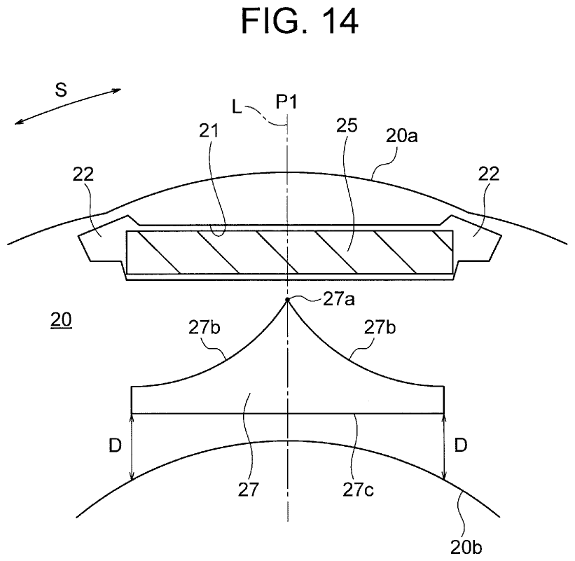

Each core hole 24 is formed on the inner side in the radial direction of the pole center of the first magnetic pole P1 in this example, but may be formed on the inner side in the radial direction of the pole center of the second magnetic pole P2. The cross-sectional shape of the core hole 24 is a circular shape in this example, but may be, for example, a rectangular shape, or another cross-sectional shape (see FIG. 14 described later).

In the consequent pole rotor 2, no magnet is provided in the second magnetic pole P2, and thus the magnetic flux from the first magnetic pole P1 tends to be disturbed. The disturbance of magnetic flux leads to imbalance of magnetic force, and causes vibration or noise. By disposing the core hole 24 at the pole center of the first magnetic pole P1 or the second magnetic pole P2, the flow of magnetic flux can be rectified, thereby reducing vibration and noise.

Since the number of core holes 24 is half the number of poles and the position of each core hole 24 in the circumferential direction is coincident with the pole center of the first magnetic pole P1, the weight balance of the rotor core 20 in the circumferential direction is improved. However, the number of core holes 24 is not limited to half the number of poles.

The separating portion 3 is provided between the shaft 11 and the rotor core 20. The separating portion 3 holds the shaft 11 and the rotor core 20 so that the separating portion 3 and the rotor core 20 are apart from each other. The separating portion 3 is formed of a nonmagnetic body. Moreover, the separating portion 3 has electrical insulation property. The separating portion 3 is preferably formed of a resin, and more preferably a thermoplastic resin such as PBT.

The separating portion 3 includes an inner annular portion 31 that is in contact with an outer circumference of the shaft 11, an outer annular portion 33 that is in contact with the inner circumference 20b of the rotor core 20, and a plurality of ribs 32 connecting the inner annular portion 31 and the outer annular portion 33 to each other. The ribs 32 are arranged at equal intervals in the circumferential direction about the center axis C1. The number of ribs 32 is, for example, half the number of poles, and is five in this example.

The shaft 11 passes through the inner annular portion 31 of the separating portion 3 in the axial direction. The ribs 32 are arranged at equal intervals in the circumferential direction and radially extend from the inner annular portion 31 to the outer side in the radial direction. Cavities 35 are formed each between the ribs 32 that are adjacent in the circumferential direction. It is desirable that the cavities 35 pass through the rotor 2 in the axial direction.

In this example, the number of ribs 32 is half the number of poles, and the position of each rib 32 in the circumferential direction is coincident with the pole center of the second magnetic pole P2. Therefore, the weight balance of the rotor 2 in the circumferential direction is improved. However, the number of ribs 32 is not limited to half the number of poles. Further, the position of each rib 32 in the circumferential direction may be coincident with the pole center of the first magnetic pole P1.

In the consequent pole rotor 2, no magnet is provided in the second magnetic pole P2, and thus magnetic flux tends to flow to the shaft 11. The configuration in which the shaft 11 is separated from the rotor core 20 via the separating portion 3 formed of the nonmagnetic body is especially effective in reducing the magnetic flux leakage in the consequent pole rotor 2.

The separating portion 3 has electrical insulation property, and thus the rotor core 20 and the shaft 11 are electrically insulated from each other. As a result, a current flowing from the rotor core 20 to the shaft 11 (referred to as a shaft current) is suppressed. Thus, electrolytic corrosion of each of the bearings 12 and 13 (that is, damage to raceway surfaces of an inner ring and an outer ring and rolling surfaces of rolling elements) is suppressed.

Further, the resonance frequency (the natural frequency) of the rotor 2 can be adjusted by changing the length in the radial direction and the width in the circumferential direction of each rib 32 of the separating portion 3. For example, as the length of the rib 32 decreases and the width of the rib 32 increases, the resonance frequency of the rotor 2 increases. As the length of the rib 32 increases and the width of the rib 32 decreases, the resonance frequency of the rotor 2 decreases. Since the resonance frequency of the rotor 2 can be adjusted by the dimensions of each rib 32 in this way, it is possible to suppress torsional resonance between the motor 1 and a blade attached thereto and resonance of an entire unit including a fan. Accordingly, noise can be suppressed.

Moreover, part of the separating portion 3 enters into the core holes 24 of the rotor core 20, as illustrated in FIG. 4. Since part of the separating portion 3 enters into the core holes of the rotor core 20 in this way, misalignment in the circumferential direction between the rotor core 20 and the separating portion 3 can be suppressed.

As illustrated in FIG. 4, the separating portion 3 has an end surface portion 38 that covers one end surface (in this example, a counter-load side end surface) of the rotor core 20 in the axial direction and an end surface portion 39 that covers the other end surface (in this example, a load side end surface) of the rotor core 20 in the axial direction. The end surface portion 38 does not necessarily entirely cover the one end surface of the rotor core 20. It is sufficient that the end surface portion 38 covers at least a part of the one end surface. The same can be applied to the end surface portion 39.

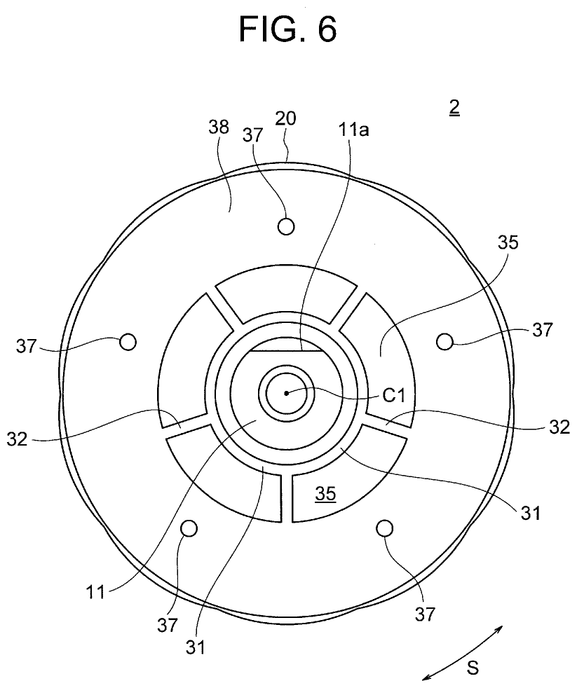

FIG. 6 is a diagram of the rotor 2 as seen in the direction indicated by an arrow 6 in FIG. 3, that is, a front view of the rotor 2. As described above, the end surface portion 38 covers one end surface of the rotor core 20 in the axial direction. In addition, the end surface portion 38 has holes (referred to as resin holes) 37 at positions corresponding to the core holes 24 of the rotor core 20. The resin holes 37 are formed for the reason that the pins 78 of the molding mold 9 (FIG. 10) are engaged with the core holes 24 of the rotor core 20 (and thus the resin does not to enter therein).

Since the pins 78 of the molding mold 9 engage with all the five core holes 24 in this example, the resin holes 37 of the same number as the core holes 24 are formed in the end surface portion 38. However, in a case where the number of pins 78 of the molding mold 9 is smaller than the number of core holes 24, the resin enters into the core holes 24 with which the pins 78 do not engage, and therefore the resin holes 37 of the same number as the pins 78 are formed.

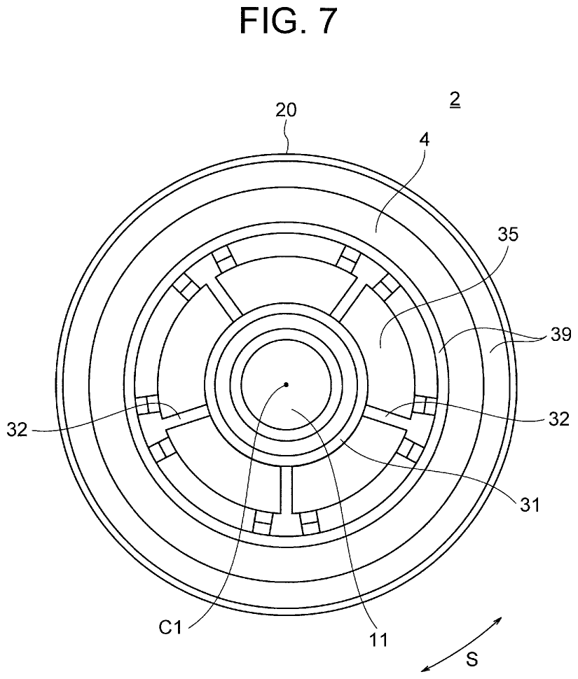

FIG. 7 is a diagram of the rotor 2 as seen in a direction indicated by an arrow 7 in FIG. 3, that is, a rear view of the rotor 2. The end surface portion 39 covers the other end surface of the rotor core 20 in the axial direction and holds an annular sensor magnet 4 described below so that a surface of the sensor magnet 4 is exposed. However, the end surface portion 39 may entirely cover the sensor magnet 4.

As illustrated in FIG. 4, the sensor magnet 4 is disposed to face the rotor core 20 in the axial direction and is surrounded and held by the end surface portion 39. The sensor magnet 4 has magnetic poles, the number of which is the same as the number of poles of the rotor 2 (in this example, 10). The magnetic field of the sensor magnet 4 is detected by a magnetic sensor mounted on the substrate 6, so that the position of the rotor 2 in the circumferential direction (the rotational position) is detected. The sensor magnet 4 is also referred to as a position detecting magnet.

### (Configuration to Reduce Magnetic Flux Leakage)

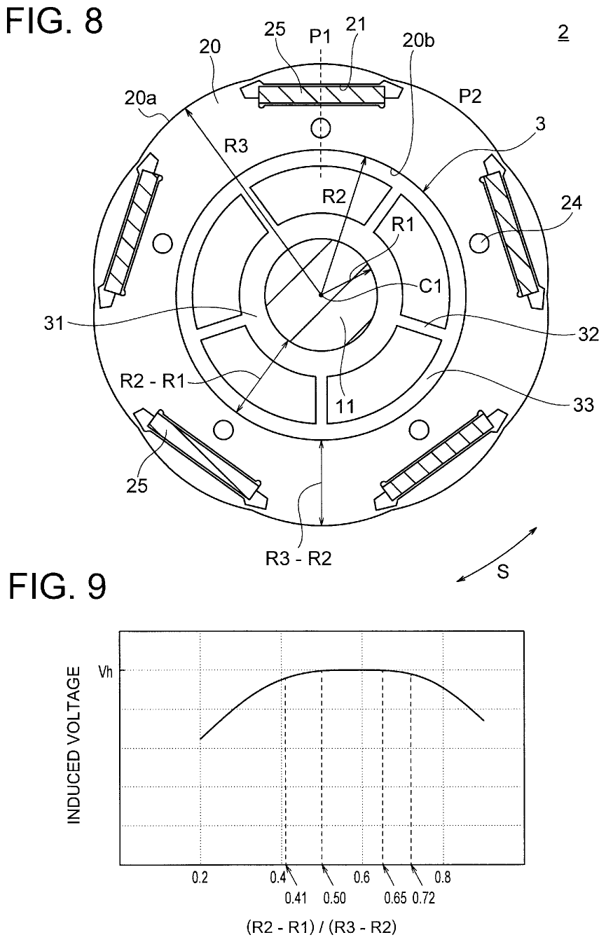

Next, a configuration for reducing magnetic flux leakage to the shaft 11 will be described. FIG. 8 is a schematic diagram illustrating dimensions of parts of the rotor 2. As illustrated in FIG. 8, the radius of the shaft 11 is represented by R1. The minimum distance from the center axis C1 to the outer circumference of the separating portion 3 (i.e., the outer circumference of the outer annular portion 33) is represented by R2. The maximum distance from the center axis C1 to the outer circumference 20a of the rotor core 20 is represented by R3.

In this example, the outer circumference of the outer annular portion 33 of the separating portion 3 has a circular cross-sectional shape perpendicular to the axial direction, and thus the distance from the center axis C1 to the outer circumference of the outer annular portion 33 is constant regardless of a position in the circumferential direction. However, the outer circumference of the outer annular portion 33 is not limited to the circular shape. Thus, the distance R2 is defined as the minimum distance from the center axis C1 to the outer circumference of the outer annular portion 33.

The outer circumference 20a of the rotor core 20 has the flower circle shape described above, and the outer diameter of the outer circumference 20a is maximum at the pole centers of the magnetic poles P1 and P2. Therefore, the maximum distance R3 from the center axis C1 to the outer circumference 20a of the rotor core 20 is the distance from the center axis C1 to the outer circumference 20a at the pole center. The relation among R1, R2, and R3 will be described later.

R2−R1 means the minimum distance from the shaft 11 to the rotor core 20. Meanwhile, R3−R2 means the maximum width of a magnetic path (i.e., a passage of magnetic flux) in the rotor core 20.

As R2−R1 increases, the rotor core 20 is separated from the shaft 11, and thus magnetic flux leakage to the shaft 11 is less likely to occur. However, there is a limit to the reduction in the radius R1 of the shaft 11, since it is necessary to secure the strength of the shaft 11. In order to increase R2−R1, it is necessary to increase the distance R2.

However, if the distance R2 is increased, R3−R2 decreases, thus making the magnetic path in the rotor core 20 narrower. Thus, part of the magnetic flux of the magnets 25 cannot be used effectively, and the motor efficiency decreases.

In the first embodiment, attention is focused on (R2−R1)/(R3−R2), i.e., the ratio of (R2−R1) to (R3−R2). How the induced voltage changes with change of the value of (R2−R1)/(R3−R2) is analyzed using simulation. The induced voltage is a voltage induced in the coil 53 of the stator 5 by the magnetic field of the magnets 25 (rotating magnetic field) when the rotor rotates. As the induced voltage increases, higher motor efficiency is obtained.

FIG. 9 is a graph showing a relation between (R2−R1)/(R3−R2) and the induced voltage. The horizontal axis represents (R2−R1)/(R3−R2). The vertical axis represents the induced voltage expressed as a relative value. The highest value of the induced voltage is denoted by Vh. This graph is obtained by analyzing change of the induced voltage using simulation while setting both R1 and R3 to fixed values and changing the value of R2.

As can be seen from FIG. 9, the induced voltage is low when (R2−R1)/(R3−R2) is small. This is because the magnetic flux leakage from the rotor core 20 to the shaft 11 is more likely to occur when R2−R1 is small, that is, when the distance between the shaft 11 and the rotor core 20 is short.

On the other hand, as (R2−R1)/(R3−R2) increases, the induced voltage also increases. When (R2−R1)/(R3−R2) is greater than or equal to 0.41, the increase in the induced voltage starts to be saturated. This is because the distance between the shaft 11 and the rotor core 20 (i.e., R2−R1) is long enough to make the magnetic flux leakage to the shaft 11 less likely to occur, and the width of the magnetic path in the rotor core 20 (i.e., R3−R2) is not extremely narrow. In the curve illustrated in FIG. 9, a point at which (R2−R1)/(R3−R2) is 0.41 corresponds to an inflection point.

When (R2−R1)/(R3−R2) is in a range from 0.50 to 0.65, the increase in the induced voltage reaches the saturated state, and the highest induced voltage is obtained. This is because, in this range, a sufficient distance between the shaft 11 and the rotor core 20 is obtained to reduce the magnetic flux leakage to the shaft 11, and a sufficient width of the magnetic path in the rotor core 20 is obtained to effectively utilize the magnetic flux of the magnets 25.

When (R2−R1)/(R3−R2) is greater than 0.72, the induced voltage decreases. This is because part of the magnetic flux of the magnets 25 is not effectively utilized when R3−R2 is small, that is, when the magnetic path in the rotor core 20 is narrow. In the curve illustrated in FIG. 9, a point at which (R2−R1)/(R3−R2) is 0.72 corresponds to an inflection point.

From the above-described results, it is understood that when (R2−R1)/(R3−R2) is 0.41 or more and 0.72 or less, the magnetic flux leakage to the shaft 11 is reduced, and thus the high motor efficiency is obtained.

Further, from the above-described results, it is understood that when (R2−R1)/(R3−R2) is 0.50 or more and 0.65 or less, the magnetic flux leakage to the shaft 11 is reduced most effectively, and thus the highest motor efficiency is obtained.

### (Manufacturing Method of Rotor 2)

Next, a manufacturing method of the rotor 2 will be described. The rotor 2 is manufactured by integrally molding the shaft 11 and the rotor core 20 with a resin. In this example, the sensor magnet 4 is also integrally molded with the resin, together with the shaft 11 and the rotor core 20.

FIG. 10 is a longitudinal sectional view illustrating the molding mold 9. The molding mold 9 includes a fixed mold (a lower mold) 7 and a movable mold (an upper mold) 8. The fixed mold 7 and the movable mold 8 respectively have mold mating surfaces 75 and 85 facing each other.

The fixed mold 7 has a shaft insertion hole 71 into which one end portion of the shaft 11 is inserted, a rotor-core insertion portion 73 into which the rotor core 20 is inserted, and a facing surface 72 that faces an end surface (in this example, a lower surface) of the rotor core 20 in the axial direction. The fixed mold 7 also has a contact portion 70 that is in contact with an outer circumferential portion of the end surface of the rotor core 20 in the axial direction, a cylindrical portion 74 that faces the outer circumferential surface of the shaft 11, cavity forming portions 76 that are inserted into inside of the rotor core 20, and the positioning pins (protrusion) 78 that protrude from the facing surface 72. The number of pins 78 may be any number equal to or smaller than the number of core holes 24 of the rotor core 20.

The movable mold 8 has a shaft insertion hole 81 into which the other end portion of the shaft 11 is inserted, a rotor-core insertion portion 83 into which the rotor core 20 is inserted, and a facing surface 82 that faces an end surface (in this example, an upper surface) of the rotor core 20 in the axial direction. The movable mold 8 also has a cylindrical portion 84 that faces the outer circumference of the shaft 11, and cavity forming portions 86 that are inserted into inside of the rotor core 20.

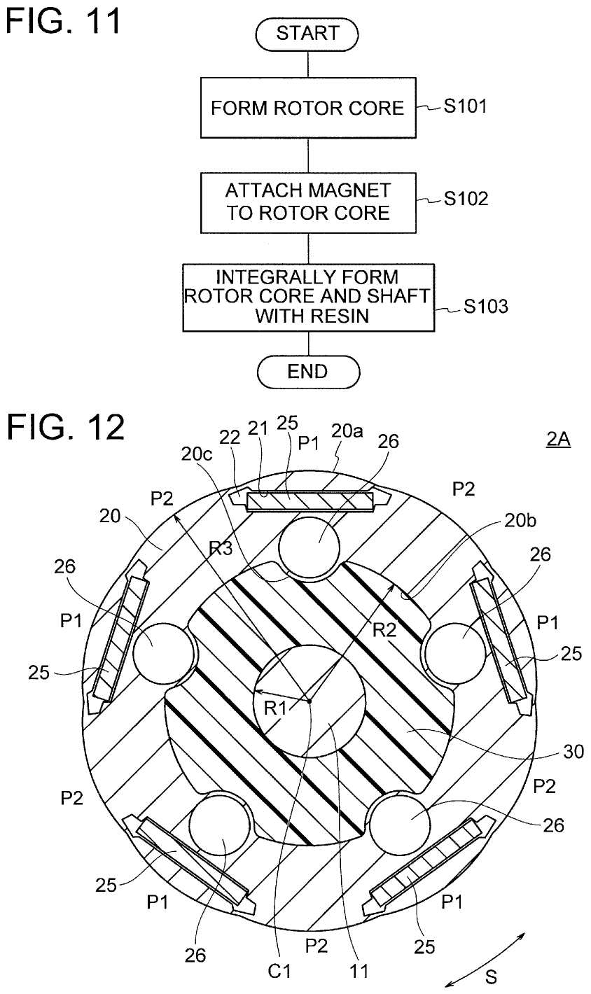

FIG. 11 is a flowchart illustrating a manufacturing process of the rotor 2. First, electromagnetic steel sheets are stacked and fixed by crimping or the like to form the rotor core 20 (Step S101). The magnets 25 are then inserted into the magnet insertion holes 21 of the rotor core 20 (Step S102).

Next, the rotor core 20 and the shaft 11 are placed in the molding mold 9, and integrally molded with a resin such as PBT (Step S103). Specifically, in FIG. 10, the shaft 11 is inserted into the shaft insertion hole 71 of the fixed mold 7, and the rotor core 20 is inserted into the rotor-core insertion portion 73.

At this time, the pins 78 of the fixed mold 7 engage with the core holes 24 of the rotor core 20. By the engagement of the pins 78 and the core holes 24, the rotor core 20 is positioned in the molding mold 9. The number of pins 78 of the fixed mold 7 is the same as the number of core holes 24 of the rotor core 20 (for example, five) in this example, and the pins 78 are arranged in a similar manner to the core holes 24. However, the number of pins 78 may be smaller than the number of core holes 24.

The core holes 24 of the rotor core 20 are disposed at equal distances from the center axis C1, and are disposed at the same relative positions with respect to the closest magnetic poles, as described above. Thus, even when the position of the rotor core 20 is changed in the circumferential direction, the core holes 24 and the pins 78 can be engaged with each other.

Further, the sensor magnet 4 is placed on the rotor core 20 via a support 77, as illustrated in FIG. 10. The support 77 is formed of a resin such as PBT, and is provided for positioning the sensor magnet 4 with respect to the rotor core 20 in molding. The support 77 is integrated with the separating portion 3 after molding. The sensor magnet 4 may be positioned by another method without using the support 77.

Thereafter, the movable mold 8 is moved down as indicated by an arrow in FIG. 10, so that the mold mating surfaces 75 and 85 are brought into contact with each other. In a state where the mold mating surfaces 75 and 85 are in contact with each other, a gap is formed between the lower surface of the rotor core 20 and the facing surface 72, and a gap is also formed between the upper surface of the rotor core 20 and the facing surface 82.

In this state, the molding mold 9 is heated, and a molten resin such as PBT is injected therein through a runner. The resin is filled inside the rotor core 20 inserted into the rotor-core insertion portions 73 and 83, filled in the magnet insertion holes 21, and filled in the core holes 24. The resin is also filled in spaces inside the cylindrical portions 74 and 84 and is further filled in the gaps between the facing surfaces 72 and 82 and the rotor core 20.

Thereafter, the molding mold 9 is cooled. Consequently, the resin in the molding mold 9 is hardened, so that the separating portion 3 is formed. That is, the shaft 11, the rotor core 20, and the sensor magnet 4 are integrated by the separating portion 3, and thus the rotor 2 is formed.

Specifically, the resin hardened between the cylindrical portions 74 and 84 of the molding mold 9 and the shaft 11 forms the inner annular portion 31 (FIG. 5). The resin hardened on the inner circumferential side of the rotor core 20 (except portions where the cavity forming portions 76 and 86 are disposed) forms the inner annular portion 31, the ribs 32, and the outer annular portion 33 (FIG. 5). Portions corresponding to the cavity forming portions 76 and 86 of the molding mold 9 form the cavities 35 (FIG. 5).

Moreover, the resin hardened between the facing surfaces 72 and 82 of the molding mold 9 and the rotor core 20 forms the end surface portions 38 and 39 (FIG. 4). Among portions of the end surface portion 38 which correspond to the core holes 24, portions with which the pins 78 of the molding mold 9 engage form the resin holes 37 (FIG. 6) because the resin does not enter into these portions.

Thereafter, the movable mold 8 is moved up, and the rotor is then taken out from the fixed mold 7. Consequently, manufacturing of the rotor 2 is completed.

Meanwhile, the stator core 51 is formed by stacking electromagnetic steel sheets and fixing them by crimping or the like. The insulating portion 52 is attached to the stator core 51, and the coil 53 is wound thereon. Consequently, the stator 5 is obtained. Further, the substrate 6 to which the lead wire 61 are assembled is attached to the stator 5. Specifically, projections provided on the separating portion 3 of the stator 5 are inserted into attachment holes of the substrate 6 and are welded by heat welding or ultrasonic welding, so that the substrate 6 is fixed to the stator 5.

The stator 5 to which the substrate 6 is fixed is then placed in a molding mold, a resin (mold resin) such as BMC is injected into the molding mold, and the molding mold is heated, so that the mold resin portion 55 is formed. Consequently, the mold stator 50 is completed.

Thereafter, the bearings 12 and 13 are attached to the shaft 11 of the above-described rotor 2, and the shaft 11 is inserted into the hollow portion 56 through the opening 55b of the mold stator 50. Next, the bracket 15 is attached to the opening 55b of the mold stator 50. Further, the cap 14 is attached outside the bracket 15. Consequently, the motor 1 is completed.

Magnetization of the magnets 25 may be performed after the completion of the rotor 2 or after the completion of the motor 1. In a case where the magnetization of the magnets 25 is performed after completion of the rotor 2, a magnetizing apparatus is used. In a case where the magnetization of the magnets 25 is performed after completion of the motor 1, a magnetizing current is applied to the coil 53 of the stator 5. In this specification, a magnet before being magnetized (that is, a magnetic material) is also referred to as a magnet.

Although the positioning pins 78 are provided in the fixed mold 7 in the example illustrated in FIG. 10, they may be provided in the movable mold 8. In either case, the rotor core 20 can be positioned with respect to the molding mold 9.

### Effects of Embodiment

As described above, in the consequent pole rotor 2 of the first embodiment, the shaft 11 and the rotor core 20 are separated from each other by the nonmagnetic separating portion 3. The radius R1 of the shaft 11, the minimum distance R2 from the center axis C1 to the outer circumference of the separating portion 3, and the maximum distance R3 from the center axis C1 to the outer circumference 20a of the rotor core 20 satisfy (R2−R1)/(R3−R2)≥0.41. Thus, the magnetic flux leakage from the rotor core 20 to the shaft 11 can be reduced, and the motor efficiency can be improved. Further, it is not necessary to make the shaft 11 thinner, and thus the sufficient strength of the motor can be obtained. Furthermore, it is not necessary to form the shaft 11 of a nonmagnetic body such as SUS or the like, and thus the manufacturing cost of the motor 1 can be reduced.

When (R2−R1)/(R3−R2)≥0.50 is satisfied, the magnetic flux leakage from the rotor core 20 to the shaft 11 can be reduced more effectively, and thus the motor efficiency can be further improved.

When (R2−R1)/(R3−R2)≤0.72 is satisfied, the width of the magnetic path in the rotor core 20 can be secured. Thus, the utilization efficiency of the magnetic flux of the magnets 25 can be improved, and the motor efficiency can be improved.

When (R2−R1)/(R3−R2)≤0.65 is satisfied, the width of the magnetic path in the rotor core 20 can be sufficiently secured. Thus, the utilization efficiency of the magnetic flux of the magnets 25 can be further improved and the motor efficiency can be further improved.

In addition, since the separating portion 3 includes the inner annular portion 31 that is in contact with the outer circumference of the shaft 11, the outer annular portion 33 that is in contact with the inner circumference 20b of the rotor core 20, and the ribs 32 that connect the inner annular portion 31 and the outer annular portion 33 to each other, the cavities 35 are formed between the ribs 32. Accordingly, material for forming the separating portion 3 can be reduced, and the manufacturing cost can be reduced. Further, since the resonance frequency of the rotor core 20 can be adjusted by the dimensions of the ribs 32, it is possible to suppress vibration and noise in, for example, a fan or the like.

Furthermore, since the separating portion 3 is made of a resin, the weight of the rotor 2 can be reduced. In addition, since the separating portion 3 can be formed by integrally molding the shaft 11, the rotor core 20, and the magnets 25 with the resin, the manufacturing process can be simplified.

Since the rotor core 20 has the core holes 24 in the end surface in the axial direction, the pins 78 provided in the molding mold 9 are allowed to engage with the core holes 24, thereby positioning the rotor core 20. Moreover, since part of the resin constituting the separating portion 3 enters into the core holes 24, misalignment between the rotor core 20 and the separating portion 3 in the circumferential direction can be prevented.

Since each the core hole 24 is located on the inner side in the radial direction of the pole center of the first magnetic pole P1 or the second magnetic pole P2, the flow of magnetic flux in the rotor core 20 can be rectified. Thus, imbalance of magnetic force can be suppressed, and vibration and noise can be reduced.

The core holes 24 of the rotor core 20 are disposed at equal distances from the center axis C1, and are disposed at the same relative positions with respect to the closest magnetic poles. Thus, even when the position of the rotor core 20 is changed in the circumferential direction in the molding mold 9, the core holes 24 and the pins 78 can be engaged with each other.

In addition, in the manufacturing process of the rotor 2, the shaft 11 and the rotor core 20 are integrally molded with a resin. Thus, a process of press fitting the shaft 11 or the like is eliminated, and the manufacturing process of the rotor 2 can be simplified. Moreover, in the molding process, the rotor core 20 can be positioned in the molding mold 9 by causing the pins 78 of the molding mold 9 to engage with the core holes 24 of the rotor core 20.

### First Modification

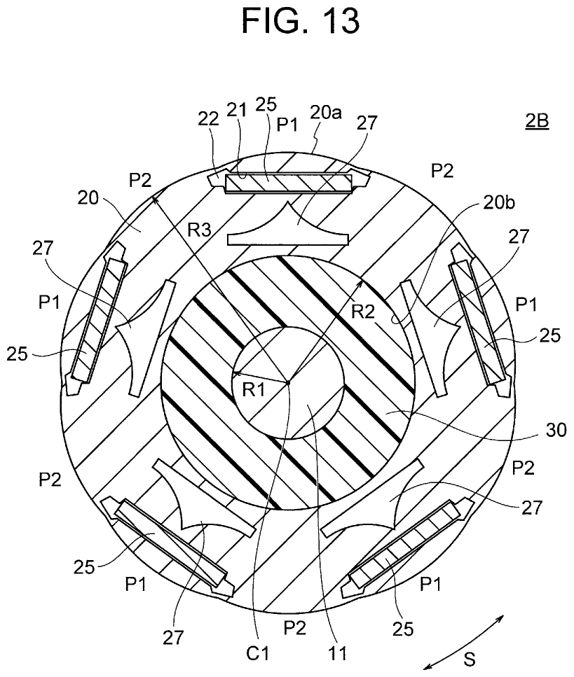

FIG. 12 is a sectional view illustrating a rotor 2A of a first modification of the first embodiment and corresponds to a sectional view taken along line 5-5 in FIG. 3 as seen in the direction indicated by arrows. The rotor 2A of the first modification is different from the rotor 2 of the first embodiment in that a separating portion 30 between the shaft 11 and the rotor core 20 does not have the ribs 32 (FIG. 5).

The separating portion 30 of the rotor 2A of the first modification is filled between the shaft 11 and the rotor core 20. The outer circumference of the separating portion 30 is in contact with the inner circumference 20b of the rotor core 20, and the inner circumference of the separating portion 30 is in contact with the outer circumference of the shaft 11. The separating portion 30 is formed by integrally molding the shaft 11, the rotor core 20, and the magnets 25 with the resin, as is the case with the separating portion 3 of the first embodiment.

In the first modification, core holes 26 of the rotor core 20 are larger than the core holes 24 of the first embodiment. The inner circumference 20b of the rotor core 20 has protrusions 20c on the inner side of the core holes 26 in the radial direction. Each protrusion 20c is arc-shaped, and extends along the outer circumference of the core hole 26. In the first modification, the distance from the center axis C1 to the protrusion 20c gives the minimum distance R2 from the center axis C1 to the outer circumference of the separating portion 30.

The relation among the radius R1 of the shaft 11, the minimum distance R2 from the center axis C1 to the outer circumference of the separating portion 30, and the maximum distance R3 from the center axis C1 to the outer circumference 20a of the rotor core 20 is as described in the first embodiment.

The rotor 2A of the first modification has the same configuration as the rotor 2 of the first embodiment except for the separating portion 30 and the core holes 26 and protrusions 20c of the rotor core 20.

Also in the first modification, the magnetic flux leakage from the rotor core 20 to the shaft 11 can be suppressed, and the motor efficiency can be improved, as in the first embodiment.

### Second Modification

FIG. 13 is a sectional view illustrating a rotor 2B of a second modification of the first embodiment and corresponds to a sectional view taken along line 5-5 in FIG. 3 as seen in the direction indicated by arrows. In the rotor 2B of the second modification, the shape of each core hole 27 of the rotor core 20 is different from either of the core hole 24 of the first embodiment and the core hole 26 of the first modification.

Each of the core hole 24 of the first embodiment (FIG. 5) and the core hole 26 of the first modification (FIG. 12) has a circular cross-sectional shape. In contrast, the core hole 27 of the second modification has a vertex facing the pole center (i.e., the center in the circumferential direction) of the first magnetic pole P1, and has a shape that spreads like a fan in the circumferential direction from the vertex toward the inner side in the radial direction.

FIG. 14 is an enlarged view illustrating a part of the rotor core 20 which includes the core hole 27. In FIG. 14, a straight line in the radial direction that indicates the pole center of the first magnetic pole P1 is defined as a pole center line L. The core hole 27 has a vertex (a facing portion) 27a facing the pole center of the first magnetic pole P1, a pair of curved side edges 27b each of which extends from the vertex 27a so that a distance from the pole center line L in the circumferential direction increases toward an inner side in the radial direction, and an inner edge 27c that extends along the inner circumference 20b of the rotor core 20.

The side edges 27b of the core hole 27 are curved so as to guide magnetic flux, which flows from the first magnetic pole P1 to the inner side in the radial direction, to both sides of the pole center line L in the circumferential direction. Therefore, the flow of magnetic flux in the rotor core 20 can be rectified. Accordingly, imbalance of magnetic force due to disturbance of the magnetic flux can be reduced, and vibration and noise can be reduced.

The inner edge 27c of the core hole 27 extends in the direction perpendicular to the pole center line L. Both ends of the inner edge 27c in the circumferential direction are at the same distance D from the inner circumference 20b of the rotor core 20. Although the side edges 27b are apart from the inner edge 27c in FIG. 14, the side edges 27b may be in contact with the inner edge 27c.

The relation among the radius R1 of the shaft 11, the minimum distance R2 from the center axis C1 to the outer circumference of the separating portion 30, and the maximum distance R3 from the center axis C1 to the outer circumference 20a of the rotor core 20 is as described in the first embodiment.

The rotor 2B of the second modification has the same configuration as the rotor 2 of the first embodiment or the rotor 2A of the first modification except for the shapes of the core holes 27 of the rotor core 20. In FIG. 13, the rotor 2B includes the separating portion 30 which is the same as that in the first modification, but the rotor 2B may include the separating portion 3 (FIG. 5) having the ribs 32 described in the first embodiment.

In the second modification, the core hole 27 has the vertex 27a facing the pole center of the first magnetic pole P1 and has a shape that spreads in the circumferential direction from the vertex 27a toward the inner side in the radial direction, and thus the flow of magnetic flux from the first magnetic pole P1 can be rectified. Thus, imbalance of magnetic force can be reduced, and vibration and noise can be reduced.

Although the vertex 27a of the core hole 27 faces the pole center of the first magnetic pole P1 in this example, the vertex 27a may face the pole center of the second magnetic pole P2.

### (Air Conditioner)

Next, an air conditioner to which the motor of the above-described first embodiment or any of the modifications is applicable will be described. FIG. 15(A) is a diagram illustrating a configuration of an air conditioner 500 to which the motor 1 of the first embodiment is applied. The air conditioner 500 includes an outdoor unit 501, an indoor unit 502, and a refrigerant pipe 503 that connects the units 501 and 502.

The outdoor unit 501 includes an outdoor fan 510 which is, for example, a propeller fan. The indoor unit 502 includes an indoor fan 520 which is, for example, a cross flow fan. The outdoor fan 510 includes the blade 505 and the motor 1 that drives the blade 505. The indoor fan 520 includes a blade 521 and the motor 1 that drives the blade 521. Each of the motors 1 has the configuration described in the first embodiment. FIG. 15(A) also illustrates a compressor 504 that compresses refrigerant.

FIG. 15(B) is a sectional view of the outdoor unit 501. The motor 1 is supported by a frame 509 disposed in a housing 508 of the outdoor unit 501. The blade 505 is attached to the shaft 11 of the motor 1 via a hub 506.

In the outdoor fan 510, the blade 505 attached to the shaft 11 is rotated by rotation of the rotor 2 of the motor 1, and blows air to the outdoors. During a cooling operation, heat discharged when refrigerant compressed in the compressor 504 is condensed in a condenser (not shown) is released to the outdoors by air-blowing of the outdoor fan 510. Similarly, in the indoor fan 520 (FIG. 15(A)), the blade 521 is rotated by rotation of the rotor 2 of the motor 1, and blows air deprived of heat in an evaporator (not shown), to the indoors.

The motor 1 of the above-described first embodiment has high motor efficiency due to reduction of magnetic flux leakage, and thus operation efficiency of the air conditioner 500 can be improved. Moreover, since the resonance frequency of the motor 1 is adjustable, resonance of the motor 1 and the blade 505 (521), resonance of the entire outdoor unit 501, and resonance of the entire indoor unit 502 can be suppressed, so that noise can be reduced.

The rotor 2A of the first modification (FIG. 12) or the rotor 2B of the second modification (FIG. 13) may be used in the motor 1. Further, although the motor 1 is used as a driving source of each of the outdoor fan 510 and the indoor fan 520 in this example, it is sufficient that the motor 1 is used as a driving source of at least one of the outdoor fan 510 and the indoor fan 520.

In addition, the motors 1 described in the first embodiment and its modifications are also applicable to electric appliances other than a fan of an air conditioner.

Although the preferred embodiment of the present invention has been described in detail above, the present invention is not limited thereto, and various improvements or modifications may be made without departing from the gist of the present invention.

1. A rotor comprising:
a shaft;
an annular rotor core surrounding the shaft from an outer side in a radial direction about a center axis of the shaft;
a magnet attached to the rotor core; and
a separating portion provided between the shaft and the rotor core and formed of a nonmagnetic body,
wherein the magnet constitutes a first magnetic pole, and a part of the rotor core constitutes a second magnetic pole,
wherein the rotor core has an inner circumference facing the shaft and an outer circumference opposite to the inner circumference,
wherein the separating portion has an outer circumference in contact with the inner circumference of the rotor core, and
wherein a radius R1 of the shaft, a minimum distance R2 from the center axis to the outer circumference of the separating portion, and a maximum distance R3 from the center axis to the outer circumference of the rotor core satisfy:
(R2−R1)/(R3−R2)≥0.41.

2. The rotor according to claim 1, wherein (R2−R1)/(R3−R2)≥0.50 is further satisfied.

3. The rotor according to claim 1, wherein (R2−R1)/(R3−R2)≤0.72 is further satisfied.

4. The rotor according to claim 1, wherein (R2−R1)/(R3−R2)≤0.65 is further satisfied.

5. The rotor according to claim 1, to wherein the separating portion has an inner annular portion in contact with an outer circumference of the shaft, an outer annular portion in contact with the inner circumference of the rotor core, and a rib that connects the inner annular portion and the outer annular portion.

6. The rotor according to claim 1, wherein the separating portion is made of a resin.

7. The rotor according to claim 1, wherein the rotor core has a core hole at an end surface in a direction of the center axis.

8. The rotor according to claim 7, wherein the core hole is formed on an inner side in the radial direction with respect to a center of the first magnetic pole or the second magnetic pole in a circumferential direction about the center axis.

9. The rotor according to claim 8, wherein the core hole has a facing portion that faces the center of the first magnetic pole or the second magnetic pole in the circumferential direction, and has a shape that spreads in the circumferential direction from the facing portion toward an inner side in the radial direction.

10. The rotor according to claim 1, wherein the rotor core has a plurality of core holes at an end surface in a direction of the center axis, the plurality of core holes being disposed at equal distances from the center axis, and
wherein the plurality of core holes are disposed at the same relative positions with respect to closest magnetic poles.

11. The rotor according to claim 10, wherein the separating portion has an end surface portion that covers at least a part of the end surface of the rotor core in the direction of the center axis, and
wherein the end surface portion has one or more holes, the number of which is equal to or smaller than the number of the plurality of core holes.

12. A motor comprising:
the rotor according to claim 1; and
a stator provided to surround the rotor from an outer side in the radial direction.

13. A fan comprising:
the motor according to claim 12, and
a blade driven by the motor to rotate.

14. An air conditioner comprising an outdoor unit, an indoor unit, and a refrigerant pipe connecting the outdoor unit and the indoor unit,
wherein at least one of the outdoor unit and the indoor unit comprises the fan according to claim 13.

15. A manufacturing method of a rotor, the method comprising the steps of:
preparing an annular rotor core to which a magnet constituting a first magnetic pole is attached and which has a part constituting a second magnetic pole, and a shaft; and
forming a separating portion between the shaft and the rotor core using a nonmagnetic resin by placing the shaft and the rotor core in a molding mold so that the rotor core surrounds the shaft,
wherein a radius R1 of the shaft, a minimum distance R2 from a center axis of the shaft to an outer circumference of the separating portion, and a maximum distance R3 from the center axis to an outer circumference of the rotor core satisfy:
(R2−R1)/(R3−R2)≥0.41.

16. The manufacturing method of a rotor according to claim 15, wherein the rotor core has a core hole in an end surface in a direction of the center axis of the shaft, and
wherein in the forming step of the separating portion, a protrusion provided in the molding mold is engaged with the core hole of the rotor core.
